(19) United States
(12) Patent Application Publication
(10) Pub. No.: US 2008/0023614 A1
(43) Pub. Date: Jan. 31, 2008

(54) Writing board for attachment to arm

(76) Inventor: Jason R. Beck, Peoria, AZ (US)

Correspondence Address: BROWNSTEIN HYATT FARBER SCHRECK, PC, 410 SEVENTEENTH STREET, SUITE 2200, DENVER, CO, 80202, US

(21) Appl. No.: 11/879,742

(22) Filed: Jul. 17, 2007

Related U.S. Application Data
(60) Provisional application No. 60/831,656, filed on Jul. 17, 2006.

(51) Int. Cl. B42F 1/00; B42D 1/00; B65D 85/88; F21V 9/16; B42D 3/00

(52) U.S. Cl. 248/444; 206/703; 281/29; 281/38; 362/600; 362/84

(57) ABSTRACT

An apparatus for securing about a person's arm. In one example, the apparatus includes a base; at least one arm band coupled to the base; an erasable writing surface positioned on the base; and a first removable cover operable to cover the erasable writing surface. The apparatus may also include a second removable cover operable to cover the first removable cover, wherein the second removable cover may be opaque. The apparatus may also include a pouch positioned on the base, the pouch operable to store a writing device. The apparatus may also include a backlight positioned between the base and the erasable writing surface.

### CROSS-REFERENCE TO RELATED APPLICATION

This application claims the benefit under 35 U.S.C. § 119(e) of U.S. provisional patent Application No. 60/831,656 entitled “WRITING BOARD FOR ATTACHMENT TO ARM” filed Jul. 17, 2006, the disclosure of which is hereby incorporated by reference in its entirety.

### BACKGROUND OF THE INVENTION

Military personnel or law enforcement officials often have dynamic plans or information that they must carry and use during an operation or mission.

As recognized by the present inventor, what is needed is an apparatus for permitting a user to write and carry notes or information on the persons body while providing easy access to that information during an operation or mission.

### SUMMARY

According to one broad aspect of one embodiment of the present invention, disclosed herein is an apparatus for securing about a person's arm. In one example, the apparatus includes a base; at least one arm band coupled to the base; an erasable writing surface positioned on the base; and a first removable cover operable to cover the erasable writing surface.

The base may define an inside surface adjacent to the user's arm wherein the inside surface includes frictional material. Likewise, the at least one arm band may include an interior surface having frictional material therein.

The erasable writing surface may take many shapes, such as rectangular or other shape as desired, and in one example the erasable writing surface may be a translucent material. The first removable cover may be translucent.

In another embodiment, the apparatus may also include a second removable cover operable to cover the first removable cover, wherein the second removable cover may be opaque. A portion of the second removable cover may be permanently attached to the base.

In another embodiment, the apparatus may also include a pouch positioned on the base, the pouch operable to store a writing device. The apparatus may also include a backlight positioned between the base and the erasable writing surface.

The apparatus may also include a compartment operable to store a battery, the compartment positioned on the base. A battery may be located within the compartment, and the apparatus may also include a switch coupled with the battery, an electro-luminescent material positioned between the base and the erasable writing surface, and a circuit for providing power from the battery to the electro-luminescent material.

According to another broad aspect of another embodiment of the present invention, disclosed herein is an apparatus comprising a base; at least one band coupled to the base; an erasable writing surface positioned on the base; and a pouch positioned on the base, the pouch operable to store a writing device.

In one example, the apparatus may also include a backlight positioned between the base and the erasable writing surface. The at least one band may include an interior surface having frictional material therein. The erasable writing surface may be a translucent material.

The apparatus may also include a second removable cover operable to cover the first removable cover, wherein the second removable cover is opaque. A portion of the second removable cover may be permanently attached to the base.

The apparatus may also include a compartment for storing a battery; a switch coupled with the battery; an electro-luminescent material positioned between the base and the erasable writing surface; and a circuit for providing power from the battery to the electro-luminescent material.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 illustrates a perspective view of an arm writing board, in accordance with embodiment of the present invention.

FIG. 2 illustrates an arm writing board attached to a wearer's arm, with the exterior cover and the interior cover in a partially opened position, in accordance with one embodiment of the present invention.

FIG. 3 illustrates an illuminating backplane coupled with a battery/switch in accordance with an embodiment of the present invention.

FIG. 4 illustrates an example of a partial view of an arm writing board in use, with the exterior cover in an open position and the user writing on the erasable writing surface, in accordance with one embodiment of the present invention.

### DETAILED DESCRIPTION

Embodiments of the present invention related to an arm writing board for use by military security, or other persons who have a need to write notes or other information and have that information be easily accessible and readable to the user. The writing board may be secured about a person's arm. Various embodiments of the present invention are described herein.

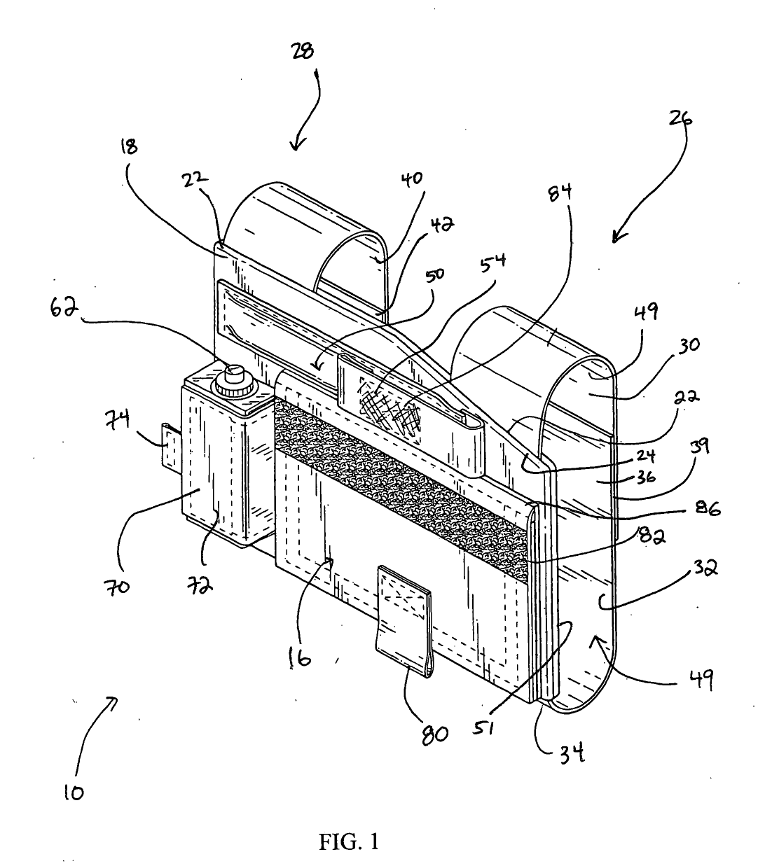

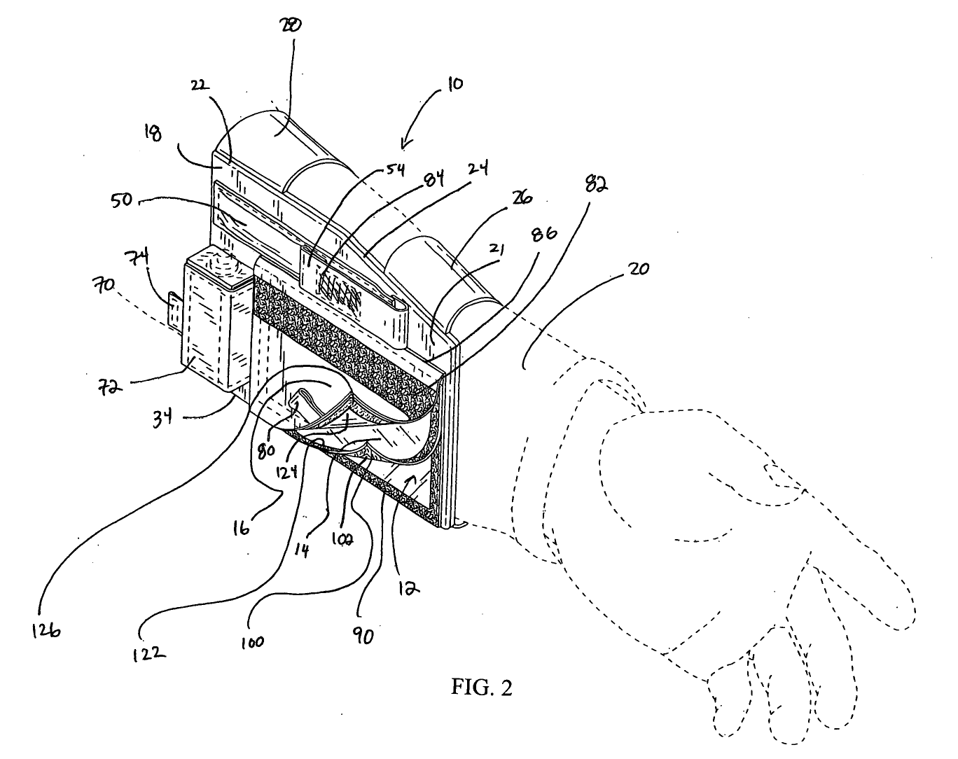

Referring to FIGS. 1-2, a writing arm board 10 in accordance with an embodiment of the present invention includes an erasable writing surface 12 which can be covered by an interior cover 14 and an exterior cover 16, in one example. The writing surface 12, along with the interior and exterior covers 14,16, may be generally rectangular as shown in FIGS. 1-2, although other shapes such as parallelograms, trapezoids, triangles, circles, or any other shape may be utilized depending upon the implementation.

The writing surface 12 is mounted upon a base 18 which is adapted to be positioned upon a wearer's arm 20, such as a wearer's forearm (right or left) as shown in FIGS. 1-2. In one example, the writing surface 12 is clear poly/vinyl material that is sewn, along three edges (bottom, right and top) of the writing surface 12, onto the top surface 21 of base 18. In one example, the left side of the writing surface 12 is not sewn closed so as to form a pocket to receive the illuminating backplane 66, described below.

The base 18 of the arm writing board 10 is generally rectangular, and may have along its upper edge 22 a downwardly angled upper edge 24. In one example, the base 18 may be formed of a substantially flat, flexible inner layer surrounded by, encased within, or sandwiched between a top and bottom layer or surface. As described below, the top layer may be nylon material, and the bottom layer (which is adapted to contact the wearer's arm or sleeve) may be made of a frictional material so as aid in keeping the arm board 10 from slipping on the wearer's arm.

The base 18 may have one or more armbands 26,28 attached thereto, such as in FIGS. 1-2 wherein the base 18 has a first arm band 26 and a second arm band 28 for attachment about a wearer's forearm 20. The first arm band 26 may be formed from a first strap 30 and a second strap 32, the straps 30,32 may be generally rectangular emanating from the upper edge 22 and lower edge 34 of the base 18, respectively, on one end, and each of the first strap 30 and second strap 32 having a free end 36,38 adapted to be secured to one another along a Velcro interface 39 (i.e., mating Velcro surfaces can be used). Likewise, second arm band 28 may have a first strap 40 and a second strap 42 that may be secured in a manner similar to the first arm band 26. In another embodiment, the first strap 26 and the second strap 28 may be secured to one another using any conventional technique or structure that is used for connecting straps together, or may be each implemented as one-piece arm bands, or may be implemented as a single arm band.

Preferably, the first arm band 26 includes frictional material 49 along an inside portion of the first arm band 26, such as rubberized material which prevents unintentional rotation of the arm band 26 about a wearer's arm 20 during use. Likewise, the second arm band 28 may also include frictional material along the inside surface (not shown), and frictional material (i.e., a rubberized surface) may also be included on the rear side or rear surface 51 of the base 18 of the arm board 10.

The second arm band 28 may include a first strap 40 extending upwardly from the top/upper edge 22 of the base 18, and a second strap 42 extending from the lower edge 34 of the base 18, the first and second straps 40,42 of the second arm band 28 adapted to be connected to one another, in one example. In another embodiment, the first arm band 26 and the second armband 28 may each be implemented as a single continuous strap connected about a loop secured to the base.

The first and second arm bands 26, 28, or portions thereof, may be made using elastic material. In one example, the arm bands 26, 28 include elastic bands of material, Velcro portions of material attached to the elastic material, and frictional portions of material also attached to the elastic material.

In one example, the arm writing board 10 may include a pouch 50 for storing a writing implement or writing device 52 such as a erasable pen or pencil. As shown in FIGS. 1-2, the pouch 50 may be generally rectangular and elongated, and closed off at three ends, having an open end covered by a pouch cover flap 54.

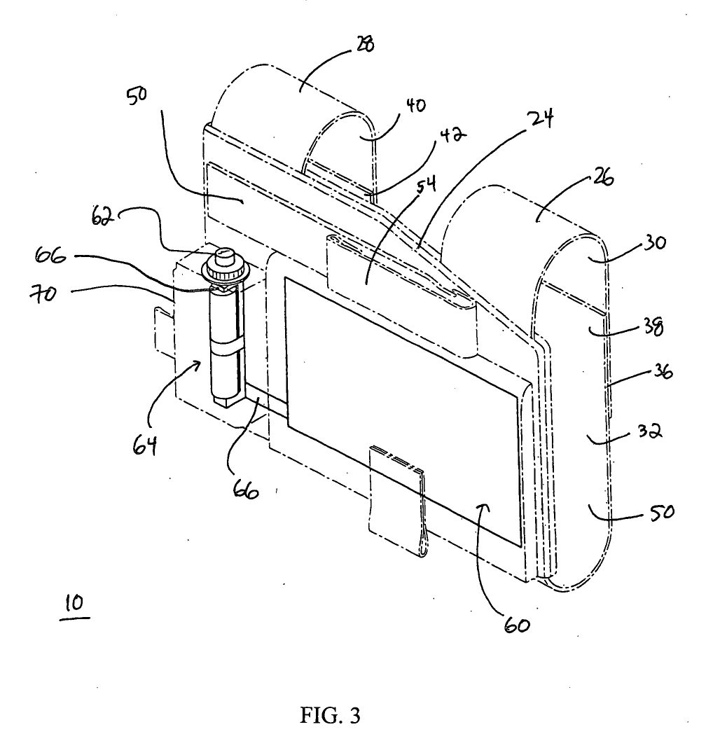

Preferably, and in one example, the arm writing board 10 is provided with an illuminating surface 60 so that the user can read the notes or other information written on the writing surface 12 in the dark or low light conditions. As shown in FIG. 3, an illuminating backplane 60 may be provided behind the erasable writing surface 12 so as to illuminate or backlight the writing surface 12 when the user depresses a switch 62.

In one example, the switch 62 may be coupled with a battery 64 and electronic circuitry 66 to provide power to the illuminating backplane 60. The switch 62 may be positioned on a top surface of compartment 70, although the location of switch 62 is a matter of choice depending upon the implementation.

In one example, the switch 62 activates a battery 64 which is coupled with an electro-illuminescent film 60 (in the shape of a rectangle in one example) through a flexible circuit interconnection 66, as shown in FIG. 3. Upon activation of the switch 62, the electro-luminescent film 60 lights up. The electro-luminescent film 60 may be any conventional electro-luminescent film, such as available from Krill Lighting products/Kriana Corporation of Prescott, Ariz.

The circuitry 66 may include a DC to AC converter to convert the DC voltage of the battery into the voltages used by the electro-luminescent film 66. Examples of such circuits can be found in U.S. Pat. Nos. 5,313,141 and 6,075,322, the disclosures of which are hereby incorporated by reference in their entirety.

The switch 62 and battery 64 may be provided in a compartment 70 with a cover flap 72 having a tab 74, as shown in FIGS. 1 and 2, that may be opened if needed to replace the battery 64 or other electrical components. The compartment 70 may be formed based on the shape of the battery 64 if desired (i.e., rectangular or cylindrical cross section, for example). In one example, the compartment defines a top, bottom, rear (provided by the base 18), front, and left side, and has an opening along the right side that can be closed by the compartment cover 72 which can utilize Velcro surfaces or other conventional securement techniques for securing the cover in a closed position.

In one example, the exterior cover/lid 16 of the arm writing board 10 includes a tab 80 for lifting the cover 16 during use. The exterior cover 16 may also include a strip 82 of Velcro that may be adapted to couple with a patch 84 of Velcro located elsewhere on the writing arm board so as to maintain the lid 16 in an open position or upward position relative to the lid's hinge 86, if desired by the user. For instance, and as one example, the pouch 50 cover flap 54 may be provided with a Velcro patch 84 (FIG. 1) so that when the lid 16 is opened, the Velcro patch 84 mates with the Velcro strip 82 of the lid 16 to maintain the lid 16 in an open position so that the user can write or make notes, or read information, without having to hold the exterior cover 16 open.

In one example, a plurality of layers 14,16,60 are provided about the erasable writing surface 12, as shown in FIG. 2. The erasable writing surface 12 may be provided as a clear poly/vinyl writing surface, and the eletro-illuminescent tape or illuminating backplane 60 shown in FIG. 3 may be positioned underneath the clear erasable writing surface 12. As shown in FIG. 2, the erasable writing surface 12 may be lined about its perimeter or outer edge 90 with Velcro. A removable interior cover 14, the interior cover 14 being clear or translucent and having an outer edge 100 along its interior surface 102 being provided with Velcro adapted to secure to the exterior outer Velcro edge 90 of the erasable writing surface 12. In this way, a user can write notes or information on the erasable writing surface 12, then apply and secure, via Velcro edges 90, 100, the removable interior cover 14 on top of the erasable writing surface 12 to protect those writings from inadvertent erasure.

The removable interior cover 14 has, on its exterior/outer surface 120, a Velcro perimeter 122, as shown in FIG. 2. The interior surface 124 of the exterior cover/lid 16 has a Velcro perimeter/edge 126 which is adapted to securely mate with the Velcro exterior outer edge 122 of the removable interior cover 14.

In one example, the interior cover 14 can be completely removed by the user from the erasable writing surface 12. A portion of the second removable cover may be permanently attached to the base 18 along hinge 86 that can be sewn onto the base 18.

In this way, when the user closes the exterior cover/lid 16, the lid 16 is secured to the removable interior cover 14, which is also secured to the erasable writing surface 12 as described above. Hence, the exterior lid/cover 16 is prevented from accidental opening during movement of the wearer's arm 20. In one example, the exterior cover 16 is made of an opaque material.

Preferably, the securing force between the removable interior cover 14 and the erasable writing surface 12 is greater than the securement between the exterior 16 cover/lid 16 and the exterior surface 120 of the removable interior cover 14—so that when all of the Velcro surfaces 90,100,122,126 of the erasable writing surface 12, the removable interior cover 14, and the exterior cover/lid 16 are all secured together, the act of opening the exterior cover/lid 16 by pulling on the cover tab 80 simply separates the exterior cover/lid 16 from the removable interior cover 14, and the removable interior cover 14 stays securely attached to the erasable writing surface 12.

In one example, Velcro edges 90, 100, 122 and 126 are formed about bottom edge, left edge, and right edge of the writing surface 12.

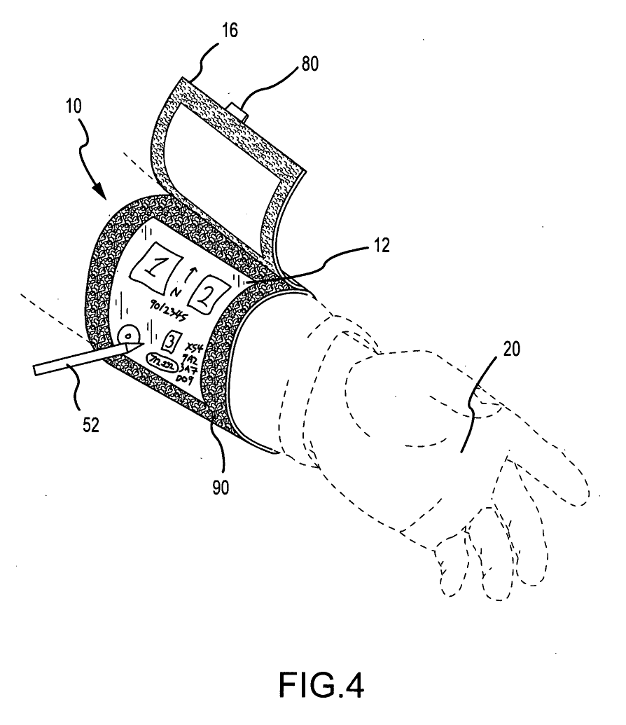

FIG. 4 illustrates an example of an arm writing board (partial view) 10 during use with the exterior cover 16 in an open position and the removable interior cover 14 having been removed so that the user can write directly on the erasable writing surface 12. In one example, the erasable writing surface 12 is marked upon by the user with a grease pencil or a non-permanent pen 52 or other conventional marking or writing tool. Moreover, preprinted cards may be utilized and inserted into the arm writing board, for example, positioned underneath the removable interior cover if desired.

In one example, the writing surface 12 of the arm writing board 10 may be dimensioned to provide a three-inch by five-inch viewable space, or other size depending upon the implementation. The battery 64 utilized may be, in one example, a 123A 3-volt lithium battery which may provide, as an example, 120 hours or more of back light illumination.

Embodiments of the invention may be formed to be secured to a wearer's right arm or left arm, forearm between the elbow and wrist, upper arm between the wearer's elbow and shoulder, or leg about the tibia or femur, depending upon the implementation.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment.

It should be appreciated that in the foregoing description of exemplary embodiments of the invention, various features of the invention are sometimes grouped together in a single embodiment, Figure, or description thereof for the purpose of streamlining the disclosure and aiding in the understanding of one or more of the various inventive aspects. Inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

1. An apparatus for securing about a person's arm, comprising:
a base;
at least one arm band coupled to said base;
an erasable writing surface positioned on said base; and
a first removable cover operable to cover the erasable writing surface.

2. The apparatus of claim 1, wherein the base defines an inside surface including frictional material.

3. The apparatus of claim 1, wherein the at least one arm band includes an interior surface having frictional material therein.

4. The apparatus of claim 1, wherein the erasable writing surface is rectangular.

5. The apparatus of claim 1, wherein the erasable writing surface is a translucent material.

6. The apparatus of claim 1, wherein the first removable cover is translucent.

7. The apparatus of claim 1, further comprising:
a second removable cover operable to cover the first removable cover, wherein the second removable cover is opaque.

8. The apparatus of claim 7, wherein a portion of the second removable cover is permanently attached to the base.

9. The apparatus of claim 1, further comprising:
a pouch positioned on said base, the pouch operable to store a writing device.

10. The apparatus of claim 1, further comprising:
a backlight positioned between the base and the erasable writing surface.

11. The apparatus of claim 1, further comprising:
a compartment operable to store a battery, the compartment positioned on said base.

12. The apparatus of claim 11, further comprising:
a battery located within the compartment;
a switch coupled with the battery;
an electro-luminescent material positioned between the base and the erasable writing surface;
a circuit for providing power from the battery to the electro-luminescent material.

13. An apparatus, comprising:
a base;
at least one band coupled to said base;
an erasable writing surface positioned on said base; and
a pouch positioned on said base, the pouch operable to store a writing device.

14. The apparatus of claim 13, further comprising:
a backlight positioned between the base and the erasable writing surface.

15. The apparatus of claim 13, wherein the at least one band includes an interior surface having frictional material therein.

16. The apparatus of claim 13, wherein the erasable writing surface is a translucent material.

17. The apparatus of claim 13, further comprising:
a second removable cover operable to cover the first removable cover, wherein the second removable cover is opaque.

18. The apparatus of claim 17, wherein a portion of the second removable cover is permanently attached to the base.

19. The apparatus of claim 13, further comprising:
a compartment for storing a battery;
a switch coupled with the battery;
an electro-luminescent material positioned between the base and the erasable writing surface; and
a circuit for providing power from the battery to the electro-luminescent material.
